(19) United States
(12) Patent Application Publication
(10) Pub. No.: US 2008/0072205 A1
(43) Pub. Date: Mar. 20, 2008

(54) Method and apparatus for designing a logic circuit using one or more circuit elements having a substantially continuous range of values

(76) Inventors: Edward B. Harris, Fogelsville, PA (US); Cynthia C. Lee, Fogelsville, PA (US); Gerard Zaneski, Macungie, PA (US)

Correspondence Address: RYAN, MASON & LEWIS, LLP, 1300 POST ROAD, SUITE 205, FAIRFIELD, CT, 06824, US

(21) Appl. No.: 11/522,733

(22) Filed: Sep. 18, 2006

(51) Int. Cl. G06F 17/50

(52) U.S. Cl. 716/18

(57) ABSTRACT

Methods and apparatus are provided for designing a logic circuit using one or more circuit elements having a substantially continuous range of values. A circuit is designed based on a functional description of the circuit and one or more circuit constraints. The circuit is initially designed using a library of discrete circuit element options. The initial circuit design is evaluated to determine whether one or more discrete circuit elements cause the circuit to not satisfy the one or more circuit constraints, such as power, area or timing requirements for the circuit. At least one replacement circuit element is generated that has at least one cell parameter configured such that the at least one replacement circuit element will have a performance characteristic that allows the circuit to satisfy the one or more circuit constraints. The at least one cell parameter for the at least one replacement circuit element is configurable so that the performance characteristic can be selectable from a substantially continuous range of values. The at least one of the discrete circuit elements is replaced in the circuit with at least one of the replacement circuit elements.

### FIELD OF THE INVENTION

The present invention relates generally to circuit design techniques, and more particularly, to methods and apparatus for digital logic design.

### BACKGROUND OF THE INVENTION

A number of commercial tools exist for designing digital logic circuits. Initially, the desired logic function, timing constraints and worst case process and temperature models are defined for the cells that will be used in a circuit. The information is then applied to a design tool that may, for example, substitute cells for more drive current, or insert higher power buffers or inverters to allow the highest speeds or lowest power operation. Sometimes, even for small delays in a critical timing path, new cells are substituted or cells are added when only small changes are need to meet the timing requirements. This can lead to additional area or power requirements than is actually needed.

Typically, a library of discrete circuit elements is employed that allows a circuit designer to select circuit elements from sets of standard gate types, such as various sizes of AND, OR and NAND gates with various configurations. Thus, a circuit designer can select a desired circuit element from the library and insert the selected circuit element into the circuit being designed. For example, an AND gate typically has two inputs and one output, but can be implemented in many different sizes to drive different loads. Thus, the library would typically contain a number of different AND gate options with discrete step sizes.

While such circuit design tools offer convenience and uniformity, they suffer from a number of limitations, which if overcome could further improve their utility. For example, due to the limited number of discrete sizes available in a library for a given circuit element type, a designer will often have to “over-design” the circuit by selecting circuit elements that meet or exceed the specifications. The use of different output drive currents in discrete steps can be wasteful of area and power.

A need exists for a framework for designing a circuit that meets design requirements.

### SUMMARY OF THE INVENTION

Generally, methods and apparatus are provided for designing a logic circuit using one or more circuit elements having a substantially continuous range of values. According to one aspect of the invention, a circuit is designed based on a functional description of the circuit, such as a register transfer language, and one or more circuit constraints. The circuit is initially designed using a library containing a plurality of discrete circuit element options. The initial circuit design is evaluated to determine whether one or more discrete circuit elements are causing the circuit to not satisfy the one or more circuit constraints. At least one replacement circuit element is then generated. The at least one replacement circuit element has at least one cell parameter configured such that the at least one replacement circuit element will have a performance characteristic that allows the circuit to satisfy the one or more circuit constraints, and the at least one cell parameter for the at least one replacement circuit element being configurable so that the performance characteristic can be selectable from a substantially continuous range of values. The at least one of the discrete circuit elements is replaced in the circuit with at least one of the replacement circuit elements. The circuit constraints can include, for example, one or more of power, area and timing requirements for the circuit.

According to another aspect of the invention, the initial circuit design is evaluated by determining whether one or more discrete circuit elements in the circuit exceed the one or more constraints. When the at least one cell parameter is channel length, the step of generating at least one replacement circuit element comprises altering a channel length of one of the discrete circuit element to generate the desired performance characteristic from the substantially continuous range of values. For example, if the discrete circuit element is a metal oxide semiconductor transistor, the step of generating at least one replacement circuit element comprises the step of altering one or more of a channel length and a channel width of the transistor to generate a desired drive current from a substantially continuous range of drive current values.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of a computer-aided circuit design system that can implement the processes of the present invention;

FIG. 2 illustrates a portion of a conventional circuit design library; and

FIG. 3 is a flow chart describing an exemplary implementation of the circuit design optimization process.

### DETAILED DESCRIPTION

FIG. 1 is a block diagram of a computer-aided circuit design system 100 that can implement the processes of the present invention. As shown in FIG. 1, a memory 130 provides the processor 120 with the requisite software, logic, data and/or process to implement the methods, steps, and functions discussed herein. The memory 130 could be distributed or local, and the processor 120 could be distributed or singular. The memory 130 could be implemented as an electrical, magnetic or optical memory, or any combination of these or other types of storage devices. It should be noted that each distributed processor that makes up processor 120 (if distributed processors are used) generally contains its own addressable memory space. It should also be noted that some or all of computer system 100 can be incorporated into an application-specific or general-purpose integrated circuit.

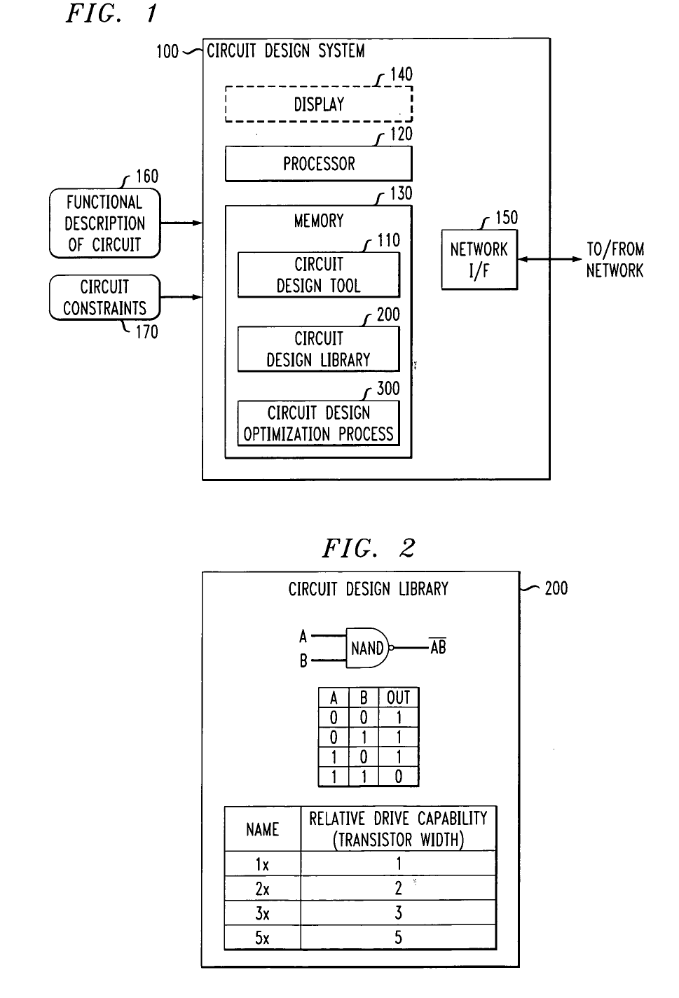

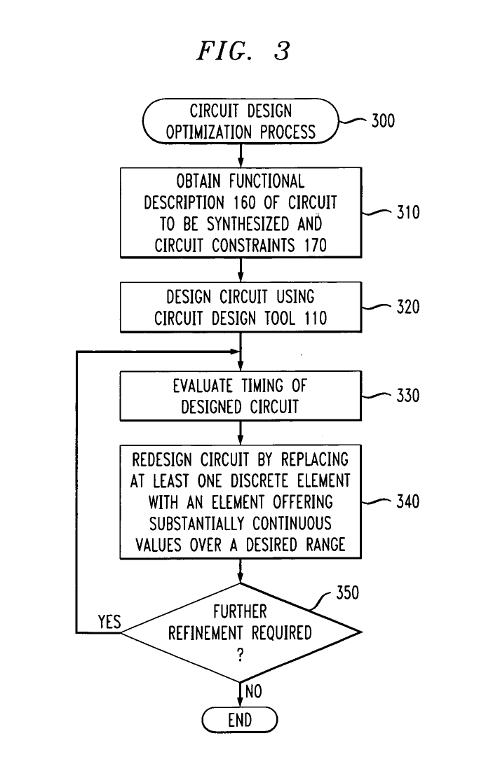

In the embodiment illustrated in FIG. 1 and discussed further below in conjunction with FIGS. 2 and 3, the memory 130 includes a circuit design tool 110, a circuit design library 200 and a circuit design optimization process 300. The circuit design tool 110 may be implemented as any commercially available circuit design tool, as modified herein to carry out the features and functions of the present invention. For example, the circuit design tool 110 may be implemented as the IC Compiler™ or Astro™ tools from Synopsis, Inc. of Mountain View, Calif. or the router tool commercially available from Cadence Design Systems of San Jose, Calif.

In the embodiment illustrated in FIG. 1, the circuit design system 100 processes a functional description 160 of the circuit to be synthesized and a set of circuit constraints 170. The functional description 160 may be specified, for example, using a register transfer language (RTL). The circuit constraints 170 can include, for example, power, area and timing requirements of the circuit.

Generally, in one exemplary embodiment, the circuit design tool 110 is initially employed to design a circuit using the circuit design library 200. As discussed further below in conjunction with FIG. 2, the circuit design library 200 contains a library of discrete circuit elements for a given gate type, such as various sizes of AND, OR and NAND gates. Once a preliminary design is obtained for the circuit, the present invention evaluates the timing and other constraints and determines if one or more elements are over-designed (i.e., exceed the specification). An over-designed element is then replaced with an element offering a finer granularity, such as a substantially continuous range of values.

The present invention thus employs a set of standard cells where key cell parameters can be varied continuously over a desired range. For example, to vary the output drive current and/or leakage current, the channel length and/or channel width of the output NMOS and/or PMOS can be selected from a substantially continuous range of values to effect the current variance.

For example, assume an imaginary timing path that does not meet the desired speed due to a weak inverter stage. Assume further that the inverter stage transistors have an output ION of 1 mA at 1 volt Vdd and are driving a load of 1 pF. The effective output resistance is then approximately 1V/1 mA (1 kohm). The charging/discharging time constraint is 1 kohm* pF (R*C) or 1 nanosecond (nsec). Now suppose that this 1 nsec time is 1% too slow to meet the timing requirements.

Using conventional techniques, an inverter with 1.5 mA of drive current (ION) could be swapped in. The problem with this approach, however, is that only an extra 1% of drive current (ION) is needed to meet the timing requirements. The extra 50% of drive current is a waste of power and area.

Instead of swapping in a 1.5 mA drive current inverter and wasting power, which is what a typical prior art system would do, the present invention can be used to increase the output current (ION) by the desired 1% with excessive power and/or area waste. As discussed hereinafter, the present invention can increase the output current ION by the desired 1% in two ways. First, the channel length of the inverter can be decreased to increase ION by 1% (with an insignificant impact on area and a slight decrease of dynamic power). Alternatively, the channel width can be increased by 1% to increase ION by 1%. The cell area may increase by 1%, but likely not as much as going to the next discrete output for a standard cell. A 1.5 mA inverter would be approximately 50% larger in area due to the larger transistors. The leakage current would only increase by approximately 1%, rather than 50% for a discrete jump.

FIG. 2 illustrates a portion of a conventional circuit design library 200. As previously indicated, the circuit design library 200 contains a library of discrete circuit elements for a given gate type, such as various sizes of AND, OR and NAND gates. The circuit design library 200 allows a circuit designer to select circuit elements from sets of standard gate types, such as various sizes of AND, OR and NAND gates with various configurations. Thus, a circuit designer can select a desired circuit element from the library and insert the selected circuit element into the circuit being designed.

In the exemplary circuit design library 200 shown in FIG. 2, a series of discrete NAND gates are provided, having standard cells of varying “strengths.” For example, the library 200 can provide four NAND gates, identified as 1×, 2×, 3×, and 5×.

Thus, if you assign a time constant, such as T=VDD*(LOAD CAP)/ION where

T equals charge/discharge time for a circuit node;

VDD equals power supply voltage;

LOAD CAP equals total load capacitance of a circuit node; and

ION equals drive current of the transistor which is directly proportional to the width.

The 2× cell, for example, will have half of the time constant than the 1× cell since the transistor width of the 2× cell is twice that of the 1× cell.

FIG. 3 is a flow chart describing an exemplary implementation of the circuit design optimization process 300. As shown in FIG. 3, the functional description 160 and circuit constraints 170 are initially received (step 310). Next, an initial circuit is designed, for example, using a conventional design tool 110 (step 320).

Thereafter, the timing and/or performance of the designed circuit are evaluated (step 330). The circuit then can be redesigned in accordance with the present invention by replacing at least one discrete element from the original design with an element offering multiple design and/or performance characteristics; e.g., a substantially continuous range of design and/or performance characteristic values. For example, an over-designed discrete element can be identified during step 340 and replaced with an element offering a substantially continuous range of values that still meets the timing requirements. In one embodiment, step 340 can be performed automatically, with the changed element presented to the designer for approval, for example, using some form of highlighting.

Finally, one or more tests can be performed to determine if a further refinement is required (step 350). If it is determined that a further refinement is required, then program control returns to step 330. If, however, it is determined that a further refinement is not required, then program control terminates.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for designing a circuit based on a functional description of the circuit and one or more circuit constraints, said method comprising:
designing said circuit using a library containing a plurality of discrete circuit element options;
evaluating whether one or more discrete circuit elements are causing the circuit to not satisfy the one or more circuit constraints;
configuring at least one replacement circuit element, the at least one replacement circuit element having at least one cell parameter configured such that the at least one replacement circuit element will have a performance characteristic which allows the circuit to satisfy the one or more circuit constraints, the at least one cell parameter for the at least one replacement circuit element being configurable so that the performance characteristic can be selectable from a substantially continuous range of values; and
replacing at least one of the discrete circuit elements in said circuit with at least one of the replacement circuit elements.

2. The method of claim 1, wherein said one or more circuit constraints include one or more of power, area and timing requirements for said circuit.

3. The method of claim 1, wherein said functional description is a register transfer language.

4. The method of claim 1, wherein said evaluating step further comprises the step of determining whether one or more discrete circuit elements in said circuit exceed said one or more constraints.

5. The method of claim 1, wherein the at least one cell parameter is channel length, and wherein the step of configuring at least one replacement circuit element comprises altering a channel length of one of the discrete circuit element to generate the desired performance characteristic from the substantially continuous range of values.

6. The method of claim 1, wherein said discrete circuit element is a metal oxide semiconductor transistor, and wherein the step of configuring at least one replacement circuit element comprises the step of altering one or more of a channel length and a channel width of said transistor to generate a desired drive current from a substantially continuous range of drive current values.

7. A system for designing a circuit based on a functional description of the circuit and one or more circuit constraints, comprising:
a memory; and
at least one processor, coupled to the memory, operative to:
design said circuit using a library containing a plurality of discrete circuit element options;
evaluate whether one or more discrete circuit elements are causing the circuit to not satisfy the one or more circuit constraints;
configure at least one replacement circuit element, the at least one replacement circuit element having at least one cell parameter configured such that the at least one replacement circuit element will have a performance characteristic which allows the circuit to satisfy the one or more circuit constraints, the at least one cell parameter for the at least one replacement circuit element being configurable so that the performance characteristic can be selectable from a substantially continuous range of values; and
replace at least one of the discrete circuit elements in said circuit with at least one of the replacement circuit elements.

8. The system of claim 7, wherein said one or more circuit constraints include one or more of power, area and timing requirements for said circuit.

9. The system of claim 7, wherein said functional description is a register transfer language.

10. The system of claim 7, wherein said processor is further configured to determine whether one or more discrete circuit elements in said circuit exceed said one or more constraints.

11. The system of claim 7, wherein the at least one cell parameter is channel length, and wherein said configuring of at least one replacement circuit element comprises altering a channel length of one of the discrete circuit element to generate the desired performance characteristic from the substantially continuous range of values.

12. The system of claim 7, wherein said discrete circuit element is a metal oxide semiconductor transistor, and wherein said configuring of at least one replacement circuit element comprises the altering one or more of a channel length and a channel width of said transistor to generate a desired drive current from a substantially continuous range of drive current values.

13. An article of manufacture for designing a circuit based on a functional description of the circuit and one or more circuit constraints, comprising a machine readable medium containing one or more programs which when executed implement the steps of:
designing said circuit using a library containing a plurality of discrete circuit element options;
evaluating whether one or more discrete circuit elements are causing the circuit to not satisfy the one or more circuit constraints;
configuring at least one replacement circuit element, the at least one replacement circuit element having at least one cell parameter configured such that the at least one replacement circuit element will have a performance characteristic which allows the circuit to satisfy the one or more circuit constraints, the at least one cell parameter for the at least one replacement circuit element being configurable so that the performance characteristic can be selectable from a substantially continuous range of values; and
replacing at least one of the discrete circuit elements in said circuit with at least one of the replacement circuit elements.

14. The article of manufacture of claim 13, wherein said one or more circuit constraints include one or more of power, area and timing requirements for said circuit.

15. The article of manufacture of claim 13, wherein said functional description is a register transfer language.

16. The article of manufacture of claim 13, wherein said evaluating step further comprises the step of determining whether one or more discrete circuit elements in said circuit exceed said one or more constraints.

17. The article of manufacture of claim 13, wherein the at least one cell parameter is channel length, and wherein the step of configuring at least one replacement circuit element comprises altering a channel length of one of the discrete circuit element to generate the desired performance characteristic from the substantially continuous range of values.

18. The article of manufacture of claim 13, wherein said discrete circuit element is a metal oxide semiconductor transistor, and wherein the step of configuring at least one replacement circuit element comprises the step of altering one or more of a channel length and a channel width of said transistor to generate a desired drive current from a substantially continuous range of drive current values.
